(19) United States
(12) Patent Application Publication
(10) Pub. No.: US 2017/0002860 A1
(43) Pub. Date: Jan. 5, 2017

(54) Bearing Assembly for a Drive Shaft Guided in a Protective Tube

(71) Applicant: Andreas Stihl AG & Co. KG, Waiblingen (DE)

(72) Inventors: Robert Davis, Virginia Beach, VA (US); Timo Honold, Virgina Beach, VA (US); Thomas Frandsen, Norfolk, VA (US); Christian Koestler, Virgina Beach, VA (US); Achim Rethaber, Stuttgart (DE); Björn Petersen, Grossbottwar (DE); Andreas Garstenauer, Chesapeake, VA (US); Andreas Giesea, Virginia Beach, VA (US)

(21) Appl. No.: 14/791,277

(22) Filed: Jul. 3, 2015

(51) Int. Cl. F16C 17/26; F16C 33/20; F16C 17/02

(52) U.S. Cl. CPC F16C 17/26; F16C 17/02; F16C 33/20

(57) ABSTRACT

A bearing assembly for a drive shaft guided in a protective tube is provided with bearing tube segments arranged in the protective tube one after another in a longitudinal direction of the protective tube. The bearing tube segments are penetrated by the drive shaft. The bearing tube segments include bearing sections. The bearing sections are provided with a central bearing sleeve and support elements projecting away from an outer circumference of the bearing sleeve. The bearing sleeve is radially supported by the support elements on an inner circumference of the protective tube. The bearing section with its bearing sleeve and support elements is formed as one piece. The bearing tube segments have a length measured in a longitudinal direction of the protective tube and the sum of the lengths of the bearing tube segments is greater than 60% of a length of the protective tube.

### BACKGROUND OF THE INVENTION

The invention concerns a bearing assembly for a drive shaft which is guided in a protective tube and connects a tool with a drive.

The bearing assembly is comprised of several bearing tube segments arranged within the protective tube which, in longitudinal direction of the protective tube, are positioned one after another and are penetrated by the drive shaft. At least one bearing tube segment is configured as a bearing section with a central bearing sleeve, wherein the bearing sleeve comprises support elements projecting away from the outer circumference and by means of which the bearing section is radially supported within the protective tube.

For supporting the drive shaft relative to the protective tube, the bearing sections can be arranged in the area of vibration nodes of the drive shaft. There are also bearing tubes known which are embodied as an extruded plastic tube and inserted into the protective tube and fill the latter across the entire length of the protective tube.

The invention has the object to provide a bearing assembly for a drive shaft guided within a protective tube that can be produced in a simple way, mounted easily, and adapted to various installation conditions.

### SUMMARY OF THE INVENTION

According to the invention, a bearing assembly is provided that supports a drive shaft which is guided within a protective tube and connects a tool with a drive. The bearing assembly is comprised of several bearing tube segments arranged in the protective tube. The bearing tube segments are positioned in longitudinal direction of the protective tube one after another and are penetrated by the drive shaft. At least one bearing tube segment is configured as a bearing section with a central bearing sleeve and comprises support elements that are projecting away from the outer circumference of the bearing sleeve. The bearing sleeve is radially supported by the support elements relative to the inner circumference of the protective tube. In this context, the bearing section that forms a bearing tube segment and is comprised of the bearing sleeve and the support elements is embodied as one piece. Into the protective tube, several sequentially arranged bearing sections are inserted, wherein the sum of the lengths of the inserted bearing tube segments is greater than 60% of the length of the protective tube; the protective tube is filled across more than 60% of its length with bearing tube segments.

The individual bearing sections are shorter than the protective tube; for filling the protective tube, several bearing sections must be inserted one after another. For simple bearing assemblies, it is sufficient to arrange and secure bearing sections at select locations of the protective tube. In order to ensure a good bearing action, the sum of the lengths of the bearing tube segments is greater than 60% of the length of the protective tube.

The configuration according to the invention of a bearing assembly that is assembled of several bearing tube segments provides for a greater design freedom. The individual bearing tube segments can be embodied so as to be adjusted to the occurring local loads so that an efficient use of material is possible. Also, the individual bearing tube segments can be configured in different physical shapes. For forming a bearing assembly, same or different bearing tube segments—for example, matched to the occurring load—can be combined variably with each other. Due to the freedom of combining the bearing tube segments, a load-adjusted bearing action of the drive shaft with minimal use of material is possible.

The arrangement of the bearing sections in the protective tube can be selected such that a first bearing section is supported on a following bearing section. In this context, a first end face of the first bearing section can rest on the following end face of the following bearing section. Possibly occurring axial forces can thus be supported.

In an advantageous further embodiment of the invention, between the bearing sections, an axial spacer element is provided as a further bearing tube segment so that sequentially arranged bearing sections are supported on each other by means of the axial spacer element.

Advantageously, it is provided that the bearing section is arranged in the protective tube in such a way that it is secured with anti-rotation action. In this way, it is ensured that the bearing section is not entrained in rotation by the rotating drive shaft and is not subjected to wear in the protective tube.

The bearing section has a section length that is significantly shorter than the protective tube. Preferably, the bearing section has a section length of 10 mm to 300 mm, expediently 100 mm to 200 mm. In an advantageous embodiment, a section length of 150 mm is selected.

The bearing section is preferably embodied as an injection-molded plastic part so that a simple inexpensive manufacture is provided.

The bearing section, on the one hand, comprises stiff support elements and, on the other hand, elastically embodied support elements. The bearing sleeve, the stiff support elements, and the elastic support elements are formed as one piece. The stiff support element ends at a maximum outer diameter about the bearing sleeve that is smaller or identical to the inner diameter of the protective tube. Relative to the longitudinal center axis of the bearing sleeve, the stiff support element is oriented perpendicular to the longitudinal center axis.

About the circumference of the bearing sleeve, several support elements can be provided that are designed as support arms, for example.

Across the length of the bearing sleeve, several support elements are arranged that are positioned at an axial spacing relative to each other. The axial spacing of sequentially arranged support elements can be identical.

A support element is preferably designed as a support ring wherein, in the outer rim of the support ring, a cutout is formed by means of which an anti-rotation action of the bearing section in the protective tube is achieved.

Expediently, a first bearing section is inserted from the first axial end of the protective tube and the second bearing section from the second axial end of the protective tube into the latter. The elastic support elements of the first bearing section that is inserted from the first end of the protective tube are deflected about a first angle opposite to the first insertion direction of the bearing section. The elastic support elements of the second bearing section that is inserted from the second end of the protective tube are deflected by a second angle opposite to the second insertion direction of the bearing section. The first angle forms preferably an alternate angle relative to the second angle.

### BRIEF DESCRIPTION OF THE DRAWINGS

Further features of the invention result from the additional claims, the description, and the drawings in which an embodiment of the invention is illustrated that will be described in more detail in the following.

FIG. 1 shows a schematic illustration of a trimmer carried by a user, comprising a drive shaft which is guided within a protective tube.

FIG. 2 shows in a perspective illustration a bearing section for arrangement in the protective tube of the trimmer.

FIG. 3 shows a side view of the bearing section of FIG. 2.

FIG. 4 shows a longitudinal section view of the bearing section of FIG. 3.

FIG. 5 shows in section view the arrangement of bearing sections in a protective tube.

FIG. 6 shows a section view of bearing sections that engage each other at the ends.

FIG. 7 shows a section view of bearing sections supported on each other by means of a spacer element.

FIG. 8 shows in schematic illustration an arrangement of several bearing sections in a protective tube.

FIG. 9 shows an arrangement of bearing sections in a protective tube wherein the bearing sections are supported on each other by means of spacer elements.

FIG. 10 shows an arrangement of bearing sections with spacer elements which are embodied to be several times longer than a bearing section.

FIG. 11 shows a section view of the bearing sections along the section line XI-XI of FIG. 4.

FIG. 12 shows a plan view of an end of the bearing section in the direction of arrow 12 in FIG. 2.

FIG. 13 shows a section view of a protective tube at the location of a bearing section with elliptical support elements.

FIG. 14 shows a section view of a protective tube at the location of a bearing section with circular support elements.

FIG. 15 shows a section view of a protective tube at the location of a bearing section with support elements embodied as radial support arms.

FIG. 16 shows a schematic section view of the full length of a protective tube with an arrangement of bearing tube segments according to FIG. 8.

FIG. 17 shows a schematic section view of the full length of a protective tube with an arrangement of bearing tube segments according to FIG. 9.

FIG. 18 shows a schematic section view of the full length of a protective tube with an arrangement of bearing tube segments according to FIG. 10.

FIG. 19 shows in a schematic illustration the arrangement of bearing tube segments in the form of bearing sections in a curved protective tube.

### PREFERRED EMBODIMENTS

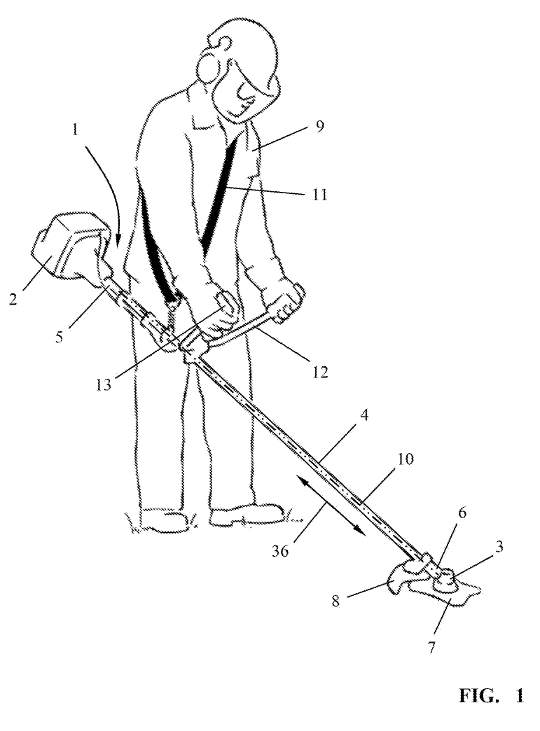

The power tool illustrated in FIG. 1 is a trimmer 1 which is substantially comprised of a drive 2, a tool head 3, and a protective tube 4. The trimmer 1 is one example of a power tool with a protective tube 4; the power tool can also be a pole pruner, a special harvesting device, a hedge trimmer or the like.

The drive 2 is attached to one end 5 of the protective tube 4 while the tool head 3 is mounted on the other end 6 of the protective tube 4. In the illustrated embodiment, the tool head 3 carries a tool 7 of the brush knife kind; multi-blade knives as well as trimmer line cutters or the like can be mounted also as a tool. For protecting the user 9, in the area of the lower end 6 a deflector 8 is secured at the protective tube 4.

In the illustrated embodiment, the trimmer 1 is carried with a belt 11 by the user 9; a grip 12 fastened to the protective tube 4, in the embodiment designed as a handlebar grip, serves for holding and guiding the trimmer 1 by the user 9. In at least one grip 12 of the handlebar grip operating elements for the drive 2 are provided. The drive 2 can be embodied as an electric motor, two-stroke motor, four-stroke motor or the like.

By means of a drive shaft 10 that is guided within the protective tube 4, the tool 7, in the embodiment a cutter blade, is rotatingly driven by the drive 2.

Within the protective tube 4, the drive shaft 10 is supported so that it can transmit with smooth running the drive power of the drive 2 onto the tool head 3.

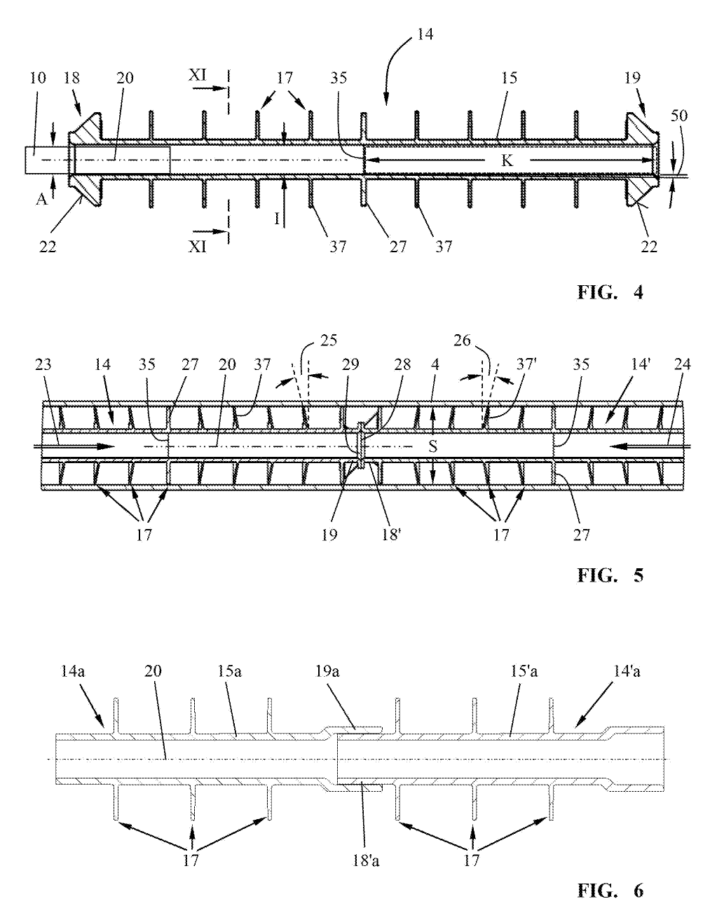

Within the protective tube 4, at least one bearing section 14 is arranged wherein in the longitudinal direction 36 of the protective tube 4 several bearing sections are positioned one after another and are penetrated by the drive shaft 10 (FIGS. 5, 8). A bearing section 14 which is illustrated in FIGS. 2 to 4 is comprised substantially of a central bearing sleeve 15 having arranged on its outer circumference 16 radially projecting support elements 17. The bearing sleeve 15 and the support elements 17 are preferably embodied as one piece. The bearing sleeve 15 has an inner diameter I (FIG. 4) that is matched to the outer diameter A of the drive shaft 10.

The support elements 17 of the bearing section 14 are comprised of stiff support elements 27 and/or elastic support elements 37. The shape of the stiff support elements 27 and of the elastic support elements 37 can advantageously be identical, as shown in the illustrations of FIGS. 2 to 5. The support elements 17 can also have different shapes and material thickness. In the embodiment, the stiff support elements 27 have a thickness D that is preferably thicker than the thickness d of the elastic support elements 37.

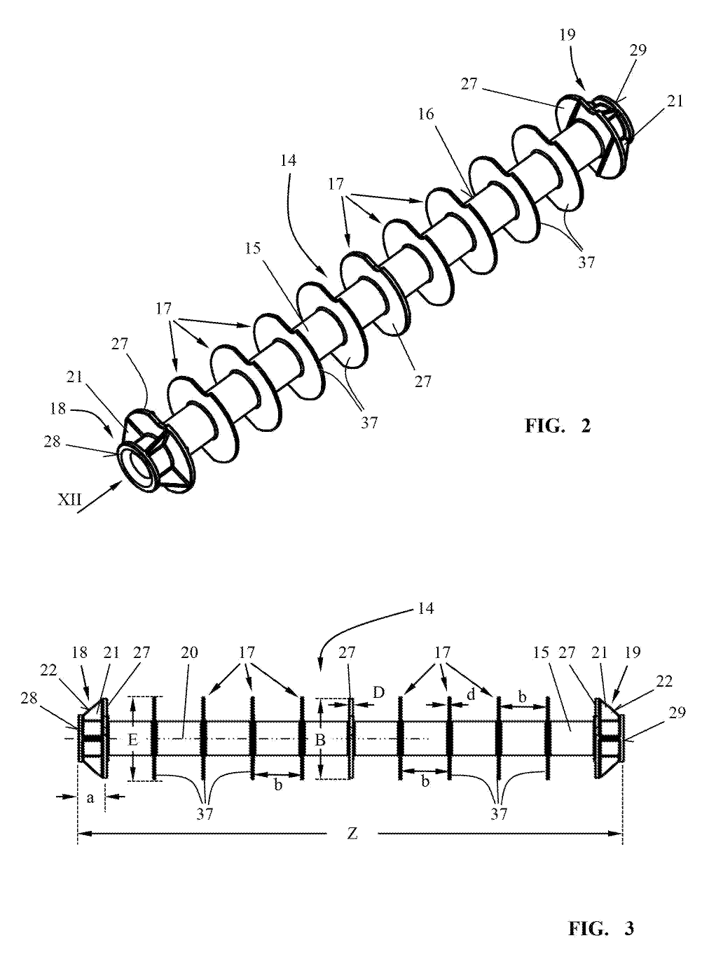

As shown in FIG. 3, for example, the stiff support element 27 has a maximum outer diameter B that is smaller or identical to the inner diameter S (FIG. 5) of the protective tube 4. Preferably, the stiff support element 27 ends on a maximum outer diameter B about the bearing sleeve 15 that is smaller or identical to the inner diameter S (FIG. 5) of the protective tube 4.

As shown in FIG. 3, the stiff support element 27 is positioned perpendicular to the longitudinal center axis 20 (FIG. 3). As shown in FIGS. 2 to 4, the bearing sleeve 15 comprises a first end 18 and a second end 19. A first stiff support element 27 is positioned between the ends 18, 19 of the bearing sleeve 15. In the illustrated embodiment, the stiff support element 27 is positioned at half the section length Z of the bearing sleeve 15.

In the illustrated embodiment, in the area of the ends 18, 19 a further stiff support element 27 is provided, respectively. In this context, the stiff support element 27 is positioned at a spacing a relative to the end face 28, 29 of the bearing sleeve 15 or the bearing section 14. Between the end 18, 19 of the bearing sleeve 15 and the stiff support element 27 at the end 18, 19 of the bearing sleeve 15, a threading element 21 is formed whose outer contour 22 rises from the end 18, 19 of the bearing sleeve 15 toward the stiff support element 27. As can be seen in FIGS. 2 to 4, the threading element 21 is designed in a side view as a triangular rib.

Advantageously, elastic support elements 37 are provided between the stiff support elements 27. It may be expedient to provide a bearing section exclusively with elastic support elements of same or different shape. As shown in FIG. 3, the elastic support elements 37 end on a maximum outer diameter E about the bearing sleeve 15. The outer diameter E is minimally greater than the inner diameter S (FIG. 5) of the protective tube 4. Minimally greater is to be understood as an outer diameter E of the elastic support element 37 that is greater by 0.5% to 5% than the inner diameter S of the protective tube 4.

As shown in FIG. 3, between the stiff support elements 27 arranged at the ends 18 and 19 and the central support element 27, four elastic support elements 37 are positioned, respectively. In particular, the support elements 27, 37 in longitudinal direction 36 of the longitudinal center axis 20 are positioned at the same axial spacing b relative to each other. Variable axial spacings b can be advantageous, e.g., the spacings b can be selected so as to be adjusted to the occurring load.

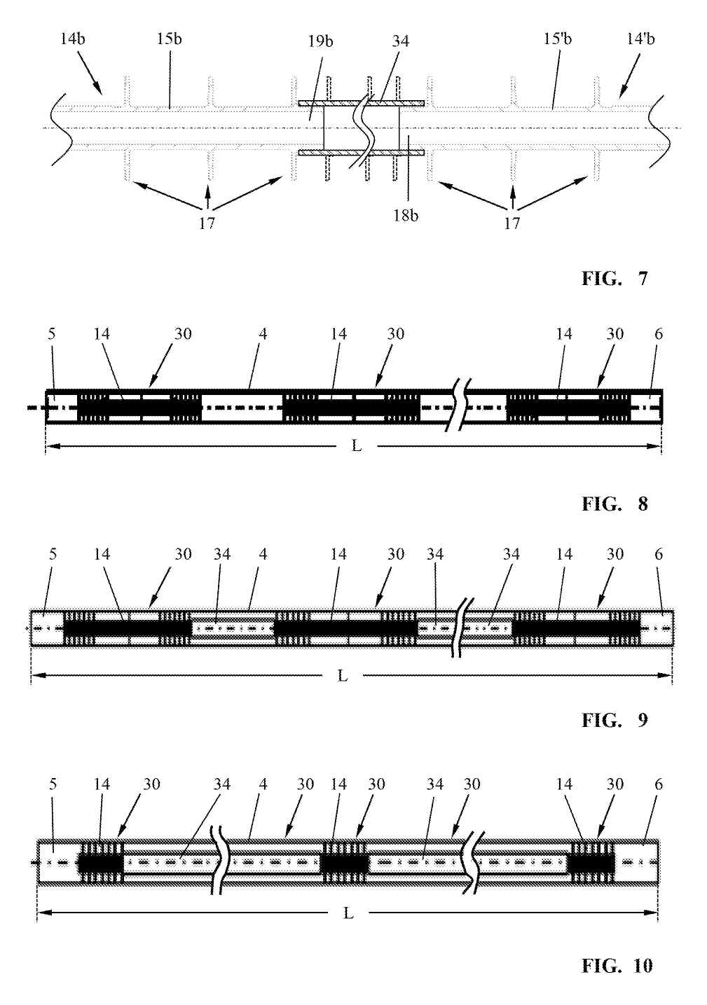

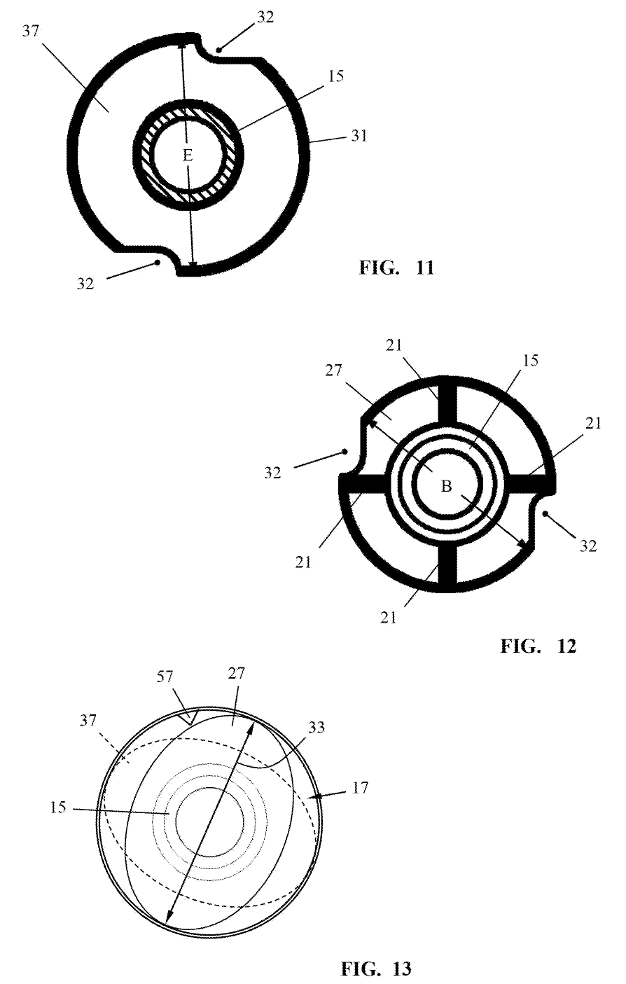

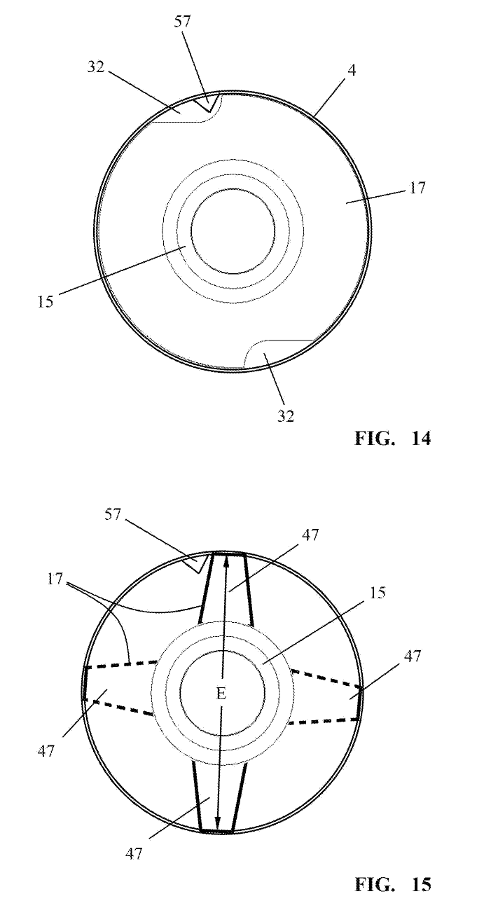

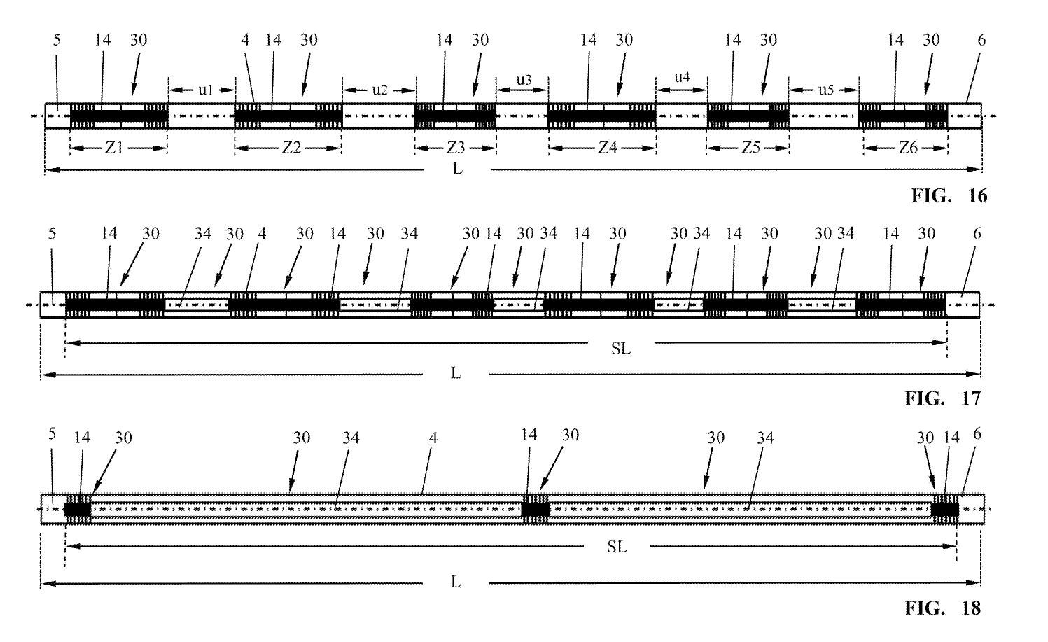

The bearing sections 14 inserted into a protective tube 4 for supporting the drive shaft 10 and optionally arranged spacer elements 34 are generally also referred to as bearing tube segments 30. According to the invention, bearing tube segments 30 are inserted into the protective tube 4 from the first end or the second end of the protective tube 4. Such a bearing tube segment 30—as shown in FIGS. 2 to 4—may be embodied as bearing section 14 or—compare FIGS. 7, 9, and 10—provided as a spacer element 34. In the protective tube 4 several sequentially arranged bearing tube segments 30 are accommodated, wherein, according to the invention, a certain degree of filling of the protective tube 4 is provided. The bearing tube segments 30, at least several bearing sections 14, fill the protective tube across more than 60% of its length. When also spacer elements 34 are provided as bearing tube segments 30, the bearing sections 14 and the spacer elements 34 fill the protective tube 4 across more than 60% of its length L. In other words, the sum of the lengths SL of the bearing tube segments 30 arranged in a protective tube 4 is greater than 60% of the length L of the protective tube 4.

In a first embodiment, as shown in FIG. 5, the filling of the protective tube can be realized across more than 60% exclusively with bearing sections 14. In this context, the end faces 28, 29 of sequentially arranged bearing sections 14 can contact each other at their ends 18 and 19. In this context, it is advantageous to insert one bearing section 14 from the first axial end of the protective tube 4 in the direction of arrow 23 into the protective tube 4 and the other bearing section 14′ from the second axial end of the protective tube in the direction of arrow 24 into the protective tube 4. Due to the oversize of the elastic support elements 37, the support elements 37 of the bearing section 14 are deflected by an angle 25 opposite to the insertion direction 23; in the same way, the elastic support elements 37′ of the bearing section 14′ are deflected opposite to the insertion direction 24 by an angle 26. Accordingly, the elastic support elements 37 of the bearing section 14 that has been inserted from the end 5 of the protective tube in the insertion direction 23 are positioned at a first angle 25 relative to the first insertion direction 23 of the bearing section 14; the elastic support elements 37′ of the bearing section 14′ that has been inserted from the other end 6 of the protective tube 4 in the insertion direction 24 are positioned at a second angle 26 relative to the second insertion direction 24 of the bearing section.

In a further embodiment of the bearing tube segments 30, their ends are designed differently, e.g., for forming a continuous bearing assembly by partial insertion into each other. With the example of the bearing sections 14a according to FIG. 6, one end 19a has been expanded to a receiving socket in such a way that the facing end 18a of a following bearing section 14′a is received in the socket. The bearing sleeves 15a, 15′a of the bearing sections 14a, 14′a engage each other at their ends and form an assembled bearing tube. The spacer elements 34 can be designed accordingly. In this way, the bearing tube segments 30, i.e., bearing sections 14 and/or spacer elements 34 can be pre-mounted to a continuous unit (bearing assembly) prior to insertion into the protective tube 4. The configuration of a bearing tube segment 30 can be designed such that its ends are embodied identical (compare e.g. the ends 18, 19 of the bearing sections 14 in FIGS. 2 to 4). Accordingly, several bearing tube segments 30 can be expediently strung together in a row in that a following bearing tube section 14 and/or a spacer element 34 at its ends is provided e.g.

with a greater diameter. Sequentially arranged bearing tube segments 30 can be connected to each other by insertion into each other. The assembly or preassembly of the bearing tube segments 30 is facilitated because the individual bearing tube segment 34 has no predetermined orientation for installation.

In the embodiment according to FIG. 7 with the example of bearing sections 14b, 14′b, the ends 18b and 19b of the bearing tube segments 30 are of identical configuration; the bearing sleeves 15b, 15′b of the bearing sections 14b, 14′b end with the same diameter; the ends are of identical design. For supporting the bearing sections 14b, 14′b relative to each other, bearing tube segments 30 are provided e.g. as spacer elements 34 which are designed like a connecting socket. The ends 18b, 19b of sequentially arranged bearing sections 14b, 14′b are inserted into the spacer element 34; the first support elements 17 which are arranged on the bearing sections 14b, 14′b delimit the insertion depth of the ends 18b and 19b into the spacer element 34. The spacer element 34 which is illustrated in FIG. 7 is designed without support elements; it may be expedient to design the spacer element 34 also as a bearing section in that on the outer circumference of the spacer element 34 support elements are arranged, as indicated in FIG. 7 by dashed lines.

In the embodiment according to FIG. 8, bearing sections 14 are exclusively provided as bearing tube segments 30 in the protective tube 4; the degree of filling across the length of the protective tube 4 with bearing sections 14 amounts to more than 60% of the length L of the protective tube 4. As illustrated in FIG. 16, spacings u1, u2, u3, u4, and u5 of different length are provided between the bearing sections 14. The bearing tube segments 30 are formed exclusively by bearing sections 14 wherein several bearing sections 14 may contact each other directly (FIG. 5) and form a first group of several bearing sections which is positioned at a spacing relative to a second group of several bearing sections. The bearing sections can have the same section length Z. In the embodiment according to FIG. 16, the bearing sections 14 are designed with different section lengths Z1, Z2, Z3, Z4, Z5, and Z6. The section lengths Z1 to Z6 as well as the spacings u1 to u5 of the bearing sections 14 relative to each other can be selected in accordance with the mechanical loads. Accordingly, a great variability results so that a load-adapted bearing assembly can be configured for the drive shaft in the protective tube.

The protective tube 4 has a length L; the sum of spacing lengths Z1, Z2, Z3, Z4, Z5, and Z6 is greater than 60% of the length L of the protective tube 4.

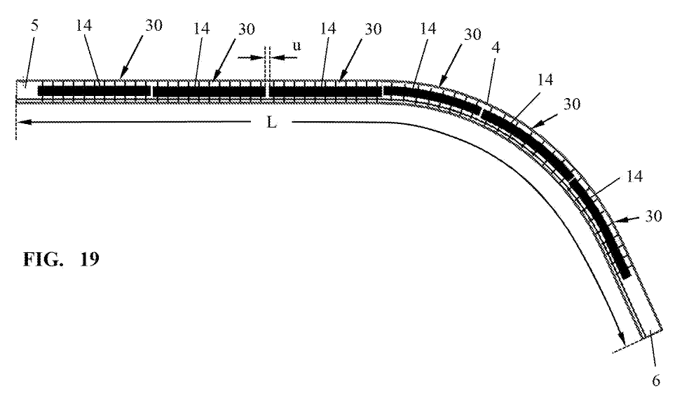

In FIG. 9, bearing tube segments 30 are sequentially arranged in the longitudinal direction 36 of the protective tube 4 wherein the bearing tube segments 30 are comprised of bearing sections 14 and spacer elements 34. As shown in FIG. 9, a bearing section 14 is provided at each end of a spacer element 34. Several bearing sections 14 can be immediately sequentially arranged, as illustrated e.g. in FIG. 5. As can be seen from the illustrated total length L of the protective tube 4 in FIG. 17, bearing sections 14 and spacer elements 34 can advantageously alternate.

The illustration of the protective tube 4 as a whole shows that not only the bearing sections 14 can have different section length (compare FIG. 16); also the spacer elements 34 can have different axial lengths. The sum of the lengths SL of the spacer elements 34 and of the bearing sections 14 is greater than 60% of the length L of the protective tube 4. In other words, the degree of filling of the protective tube 4 with bearing tube segments 30 is greater than 60% across the length L.

In the embodiment according to FIG. 9, the bearing sections 14 are approximately of the same length or longer than the spacer elements 34; this is one of the various possible configurations. In the embodiment according to FIG. 10, a configuration is provided in which the spacer elements 34 are longer, in particular several times longer, than the bearing sections 14. In FIG. 18, the filling of the protective tube 4 is illustrated which is selected across its length such that more than 60% of the length L of the protective tube 4 is filled with bearing sections 14 and spacer elements 34. In the illustrated embodiment, across the length L of the protective tube 4, three bearing sections 14 are arranged between which a spacer element 34 is arranged, respectively. The spacer elements 34 support the bearing sections 14 relative to each other; the sum of the lengths SL of the bearing sections 14 together with the length of the spacer elements 34 is greater than 60% of the length L of the protective tube 4. In the embodiment according to FIG. 18, the sum of the lengths SL is approximately 90% to 95% of the length L of the protective tube 4.

The bearing sections 14, 14a, 14b are secured with anti-rotation action in the protective tube 4. Advantageously, in accordance with FIGS. 11, 12, and 14, it is provided that the support elements 17, i.e., the stiff support elements 27 and/or the elastic support elements 37, are designed as circular rings wherein in the outer rim 31 of a circular ring at least one notch 32 is formed. The notches 32, as shown in FIG. 11, can be positioned diametrically opposite each other. A notch 32 interacts with an inner longitudinal bead 57 of the protective tube 4 which is present as a result of the manufacturing process of the protective tube 4. The protective tube 4 can be manufactured e.g. as a welded tube, a drawn tube or the like.

It can be sufficient to provide exclusively the stiff support elements 27 with notches 32, as illustrated in FIG. 12. Advantageously, the circular ring-shaped stiff support elements 27 and the circular ring-shaped elastic support elements 37 are provided with notches 32.

Alternative configurations of the support elements 17 can be advantageous. For example, FIG. 13 shows elliptically designed support elements 17 that can be provided as stiff support elements 27 and/or as elastic support elements 37. The elliptical support elements 17 have a semimajor axis 33 which, as an elastic support element, is designed in accordance with the outer diameter E in FIG. 3 or, as a stiff support element, in accordance with the outer diameter B. It can be advantageous to arrange the elliptical support elements 17 so as to be rotated relative to each other, as indicated in FIG. 13 in dashed lines. The elliptical support element 17 is secured against rotation by the longitudinal bead 57 on the inner circumference of the protective tube 4.

In an alternative embodiment according to FIG. 15, the support elements 17 are designed as support arms. Two support arms 47 each are positioned diametrically opposite each other, wherein four support arms 47 can be arranged about the circumference of the bearing sleeve 15. The support arms 47 end on a maximum outer diameter E that is greater by 0.5% to 5% than the inner diameter S of the protective tube 4 (FIG. 5). The support arms 47 can be designed as stiff and/or elastic support elements 17. It may be expedient to arrange the support arms 47 that are neighboring each other in longitudinal direction of the bearing sleeve 15 so as to be displaced relative to each other in circumferential direction, as indicated in FIG. 15 in dashed lines.

The bearing section 14 comprised of the bearing sleeve 15 and of the support elements 17 is manufactured as one piece as an injection-molded plastic part. The bearing section 14 has a section length Z in the range of 10 mm to 300 mm, preferably 100 mm to 200 mm, in particular 150 mm. The section length Z for injection molding of the bearing section 14 is limited by the length K of the core inserts during injection molding. When two core inserts are used, which preferably are meeting approximately at the center of the bearing sleeve 15, upon injection molding a butt joint results—as shown in FIG. 4—which is illustrated as a circumferentially extending inner seam 35 and which does not impair the bearing properties of the bearing sleeve 15.

In FIGS. 1 and 8 to 10, straight protective tubes of the length L are shown. The length of a protective tube 4 can be in the range of 800 mm to 1,500 mm, wherein the cross-section of the protective tube 4 is preferably round. Cross-sectional shapes for a protective tube that deviate from a round cross-section can be advantageous.

The protective tube 4 can also be of a curved configuration, as shown in FIG. 19. The bearing sections 14 and/or the spacer elements 34 can be elastically bent across their section length Z or a part of their section length Z so that e.g. a bearing section 14 is bent in accordance with the curvature of the protective tube 4. In case of large radii of curvature of the protective tube 4 also short stiff bearing sections 14 can be employed which align themselves in the protective tube and relative to the drive shaft by means of their elastic support elements. In the embodiment according to FIG. 16, the protective tube 4 is filled across more than 60% of its length L with bearing sections 14. The sum of the section lengths Z of the bearing sections 14 is greater than 60% of the length L of the protective tube 4. The bearing sections 14 can be resting with their end faces against each other. In FIG. 16, a minimal spacing u between neighboring bearing sections 14 is provided.

As shown in FIG. 4, the inner diameter I of the bearing sleeve 15 can widen in the direction toward the ends 18, 19. The inner diameter I of the bearing sleeve 15 is thus greater at the respective end 18, 19 of the bearing sleeve 15 than in the area of the center of the bearing sleeve 15, in particular at the location of the inner seam 35.

Beginning at the inner seam 35 or the center of the bearing section 14, the inner diameter I widens by an angle 50 of approximately 0.01° to 1°, preferably 0.02° to 0.1°. In this way, at the ends 18, 19 of the bearing sleeve 15 a wider diameter results.

In case of an injection molding process with identical material, it is provided according to the embodiment that elastic support elements 37 are provided by forming them with a thinner material thickness than the stiff support elements 27. When the bearing section 14 is cast by a multicomponent method, for the elastic support elements other materials can be employed than for the remaining sections of the bearing section. In this way, the same material thickness for all support elements can be provided, for example; the required elasticity can be provided as a result of different material properties.

What is claimed is:

1.-17. (canceled)

18. A bearing assembly for a drive shaft guided in a protective tube, wherein the drive shaft connects a tool with a drive, wherein the bearing assembly comprises:
bearing tube segments arranged in the protective tube one after another in a longitudinal direction of the protective tube, wherein the bearing tube segments are penetrated by the drive shaft;
wherein the bearing tube segments include first bearing tube segments;
wherein the first bearing tube segments each are embodied as a bearing section, wherein the bearing section comprises a central bearing sleeve and further comprises support elements projecting away from an outer circumference of the bearing sleeve, wherein the bearing sleeve is radially supported by the support elements on an inner circumference of the protective tube and wherein the bearing section, comprised of the bearing sleeve and the support elements, is em bodied as one piece;
wherein the bearing tube segments each have a length measured in a longitudinal direction of the protective tube and wherein the sum of the lengths of the bearing tube segments is greater than 60% of a length of the protective tube.

19. The bearing assembly according to claim 18, wherein a first one of the bearing sections is supported on a second one of the bearing sections following the first bearing section in the longitudinal direction of the protective tube.

20. The bearing assembly according to claim 19, wherein an end face of the first bearing section is resting on an end face of the second bearing section.

21. The bearing assembly according to claim 19, wherein the bearing tube segments include at least one second bearing tube segment and the at least one second bearing tube segment is an axial spacer element, wherein the axial spacer element is arranged between the first bearing section and second bearing section, wherein the first bearing section and second bearing section are supported on each other through the axial spacer element.

22. The bearing assembly according to claim 18, wherein the bearing sections are secured with anti-rotation action in the protective tube.

23. The bearing assembly according to claim 18, wherein the bearing sections each have a section length of 10 mm to 300 mm.

24. The bearing assembly according to claim 23, wherein the section length is 150 mm.

25. The bearing assembly according to claim 18, wherein the bearing sections each are formed as an injection-molded plastic part.

26. The bearing assembly according to claim 18, wherein the support elements include stiff support elements and elastically configured support elements.

27. The bearing assembly according to claim 26, wherein the bearing sleeve, the stiff support elements, and the elastic support elements together form one piece.

28. The bearing assembly according to claim 27, wherein the stiff support elements each end at a maximum outer diameter about the bearing sleeve, wherein the maximum outer diameter is smaller or identical to the inner diameter of the protective tube.

29. The bearing assembly according to claim 27, wherein the stiff support elements each are oriented perpendicular to a longitudinal center axis of the bearing sleeve.

30. The bearing assembly according to claim 18, wherein the support elements are distributed about the circumference of the bearing sleeve.

31. The bearing assembly according to claim 18, wherein the bearing sleeve has a section length and wherein across the section length of the bearing sleeve the support elements are arranged so as to be positioned at an axial spacing relative to each other.

32. The bearing assembly according to claim 18, wherein the support elements each are formed as a support ring.

33. The bearing assembly according to claim 32, wherein the support ring comprise an outer rim and the outer rim comprises a cutout.

34. The bearing assembly according to claim 18, wherein a first one of the bearing sections is inserted into the protective tube from a first axial end of the protective tube and a second one of the bearing sections is inserted into the protective tube from a second axial end of the protective tube.
